(19) United States
(12) Patent Application Publication
(10) Pub. No.: US 2016/0117250 A1
(43) Pub. Date: Apr. 28, 2016

(54) Apparatus and Method of Throttling Hardware Pre-fetch

(71) Applicant: Imagination Technologies Limited, Kings Langley (GB)

(72) Inventors: William Lee, Portland, OR (US); Thomas B. Berg, Portland, OR (US)

(21) Appl. No.: 14/919,922

(22) Filed: Oct. 22, 2015

Related U.S. Application Data
(60) Provisional application No. 62/067,090, filed on Oct. 22, 2014.

(51) Int. Cl. G06F 12/08

(52) U.S. Cl. CPC G06F 12/0862; G06F 12/0811; G06F 2212/6026; G06F 2212/283

(57) ABSTRACT

Hardware based prefetching for processor systems is implemented. A prefetch unit can be provided in a cache subsystem that allocates a prefetch tracker in response to a demand request for a cache line that missed. In response to subsequent demand requests to consecutive cachelines, a confidence indicator is increased. In response to further demand misses and a confidence indicator value, a prefetch tier is increased, which allows the prefetch tracker to initiate prefetch requests for more cachelines. Requests for cachelines that are more than two cachelines apart within a match window for the allocated prefetch tracker decreases the confidence faster than requests for consecutive cachelines increase confidence. An age counter tracks when a last demand request within the match window was received. The prefetch tier can be decreased in response to reduced confidence and increased age.

### CROSS-REFERENCE TO PENDING APPLICATIONS AND CLAIM OF PRIORITY

This application claims priority under 35 U.S.C. 119(e) to copending U.S. Provisional Application Ser. No. 62/067,090 filed Oct. 22, 2014, the contents of which are hereby incorporated by reference in their entirety.

### BACKGROUND

1. Field

In one aspect, the following relates to microprocessor microarchitecture, and in a more particular aspect, to microprocessor memory access.

2. Related Art

Many processor systems have one or more processors that each has a private Level 1 (L1) cache. In the case of a multiprocessor system, multiple processors may share a Level 2 (L2) cache. In turn, there may be additional levels of cache hierarchy (e.g., an L3 cache), and a main memory. Some multiprocessor caching approaches will duplicate data stored in each L1 within a shared L2 cache, while other approaches will not. Caches may be write back or write through. Various approaches to maintaining coherence of cached data are known.

In general, each cache level, starting from the main memory, has increasingly higher bandwidth and lower latency than the preceding one. For example, some processors may have a small number of delay cycles (e.g., between 2-4) to access data from a private L1 cache, and relatively more to access data from an L2 (e.g., 10-20), and still more to access an L3, and so on. Main memory may be implemented in Dynamic Ram (DRAM), which has different access patterns and considerably longer access time than a Static RAM (SRAM) cache.

However, each cache level from L3 to L1 is generally progressively smaller in size (e.g., an L1 data cache may be 32 kB, while an L2 cache may be 256 kB or 512 kB), an L3 cache in a multi-processor system may be multiple megabytes). Caches consume both power and area. Thus, while caches can greatly enhance performance of a processor or processor system, cache management techniques are typically used to enhance the benefit of caches.

### SUMMARY

In one aspect, the disclosure relates to a hardware-based approach to predictively fetching (prefetching) data into an L2 cache from a memory hierarchy (such as an L3 cache and main memory). In some aspects, the approach is implemented to be used with an out-of-order (00) execution processor, a multithreaded (MT) processor or a processor that supports both 00 and MT. In some aspects, the approach supports multi-processor systems, and may be implemented with circuitry that maintains coherence caches in the multi-processor system.

### BRIEF DESCRIPTION OF THE DRAWINGS

FIG. 1 depicts an apparatus context in which implementations of the disclosure may be provided;

FIG. 2 depicts an example implementation of a prefetch tracking unit that contains prefetch trackers according to the disclosure;

FIG. 3 depicts an example diagram for a prefetch tracker;

FIG. 4 depicts a diagram of a data maintained for an allocated prefetch tracker;

FIG. 5 depicts a process implemented by a prefetch tracking unit;

FIGS. 6-9 depict example respective processes for maintaining state information for an allocated prefetch tracker; and

FIG. 10 depicts an example process for updating a prefetch tier, which results in increase or decrease of a number of cache lines that the prefetch tracker can initiate prefetch requests for.

### DETAILED DESCRIPTION

Given an amount of delay incurred by an L2 cache miss, it would be desirable to fetch a cache line before data from the cache line has been demanded by a demand request. A program being executed by a processor has visibility into what data will be required by instructions in the program. Thus, it has been proposed to implement software pre-fetching hints that can be interpreted by an instruction decoder (or other circuitry) in a processor to identify data to be pre-fetched for that instruction stream. This requires a compiler to analyze the program and produce these hints. While such pre-fetching hints may provide some benefit, there are detriments to software pre-fetching. For example, a program needs to be compiled to target a particular approach to pre-fetching, which makes a program less portable. Also, if the processor can execute instructions out of order, support multi-threading, or both, a pre-fetch hint that is produced on an assumption that program execution will roughly follow the order of instructions in that program may not actually be helpful.

By contrast, a processor cannot determine what data actually will be requested by an instruction that has not yet been decoded. This disclosure presents an approach to predicting data fetch behavior for programs in hardware. In particular implementations, the disclosure can be used to implement hardware pre-fetching for one or more of an out-of-order processor, a multi-threaded processor, and an out of order, multi-threaded execution processor.

While in theory hardware-based prefetching would result in benefits, such as reduction in stalls while data is obtained from main memory, the reality is more nuanced. In particular, bandwidth across a channel for accessing main memory is a resource to be allocated. Indiscriminate prefetching of data may result in fewer demand requests being served (where a demand request is the actual data requested by an instruction). Also, an L2 cache is a limited resource, and replacement of demand-requested data in order to install pre-fetched data may result in a situation where the demand-requested data may actually be needed again, while the pre-fetched data may not be needed at all. As such, there are scenarios where pre-fetching of data may not result in an overall improvement of memory system performance, in a general sense, or for some workloads.

As such, some aspects of the disclosure present a variable pre-fetching approach where pre-fetching can become increasingly aggressive, as confidence in the usefulness of the pre-fetching increases. Still further aspects will become apparent from the following disclosure.

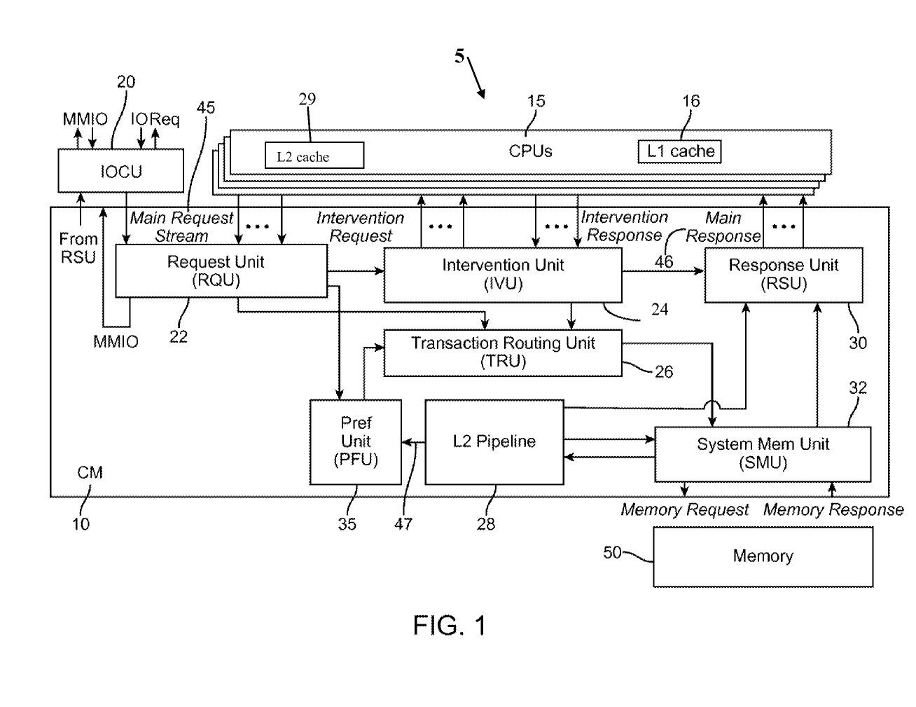

FIG. 1 depicts an apparatus 5 (such as a multiprocessor computing system) that includes a Coherence Manager 10 (CM 10). The term “coherence manager” is used for ease of reference, but implementations of the disclosure do not need to provide circuitry that includes all the features or functions of CM 10, or label any particular portion of circuitry as a “coherence manager” in order to implement the disclosure. Further, some parts of and connectivity of CM 10 with other functional elements is abstracted to present some aspects of the disclosure in greater clarity.

CM 10 couples with a plurality of CPUs 15. Each CPU 15 has a respective L1 cache 16, which can be a cache for data only, for example. CM 10 includes a request unit (RQU) 22 that couples with each CPU 15 to receive requests 45 for data; these requests can be for data that was not available in the L1 cache 16 of the processor requesting that data. Depending on coherence protocol, that data could be valid/modified) in an L1 cache of another processor, or not present in another L1 cache, but present in an L2 or L3 cache (e.g,. L2 cache 29), and/or in a main memory. CM 10 includes an intervention unit (IVU) 24 that can generate intervention requests to the L1 caches 16, which are for obtaining data that is valid/modified) in one of the caches, which has been requested by a different CPU. The CPUs 15 can return responses 46 to the intervention requests to IVU 24. Some implementations may allow an L1 cache 16 to directly forward data to another L1 cache 16, such that the data need not traverse CM 10, even though CM 10 may control the transfer and otherwise maintain status information for what data is valid/modified in different of L1 caches 16. Some implementations may update L2 cache 29 with data provided in response to an intervention request (such that this data could be served by an L2 cache pipeline 28, which provides an interface with an L2 cache 29) if requested by another processor). Various approaches exist to maintaining subdividing data among L1 caches and an L2 cache, and for maintaining coherence of such data, and the above is an example.

A transaction routing unit (TRU) 26 can receive requests from RQU 22 and determine whether to have those requests serviced by L2 cache pipeline 28, or a system memory unit 32, which couples with a memory 50 (this example does not include an L3 cache, but further levels of cache hierarchy can be accommodated in other implementations).

A prefetch unit (PFU) 35 receives demand requests, such as from RQU 22, and can send prefetch requests to TRU 26. The prefetch requests generated by PFU 35 are for data contained in memory 50 that PFU 35 has determined should be prefetched. The prefetch requests are sent to TRU 26, which determines which requests should be serviced by L2 cache pipeline 28, and which by SMU 32, arbitrates among each of those request subsets and provides respective requests to each of L2 pipeline 28 and SMU 32 to be serviced. The following discloses an example construction of PFU 35 and how PFU 35 operates.

The apparatus 5 can have a variety of different physical realizations. For example, all of the structures depicted (e.g. a CM 10 and two or four CPUs 15) can be implemented on one semiconductor substrate. In another example, one, two, four, or eight CPUs 15 could be formed on a substrate, and multiple such substrates can be coupled with a substrate containing a CM 10.

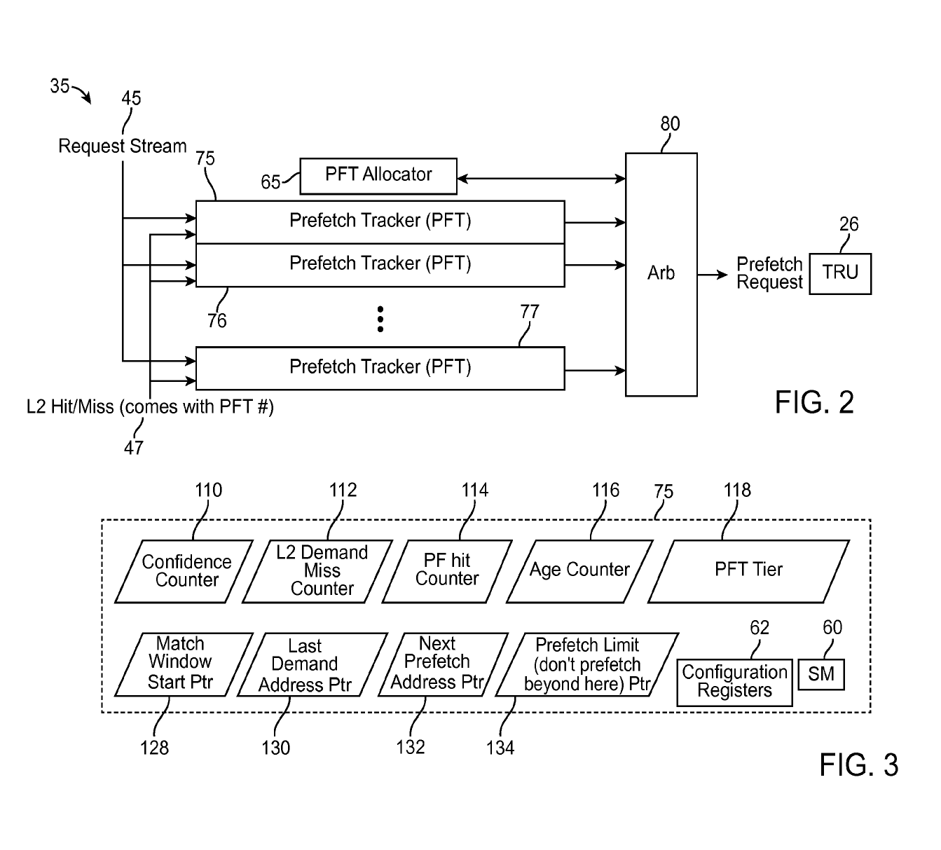

FIG. 2 depicts an example implementation of PFU 35, which includes a PFT allocator 65, a set of Prefetch Trackers (PFTs) 75-77, and an arbiter 80. In an example, sixteen PFTs can be provided; other implementations may have more or fewer PFTs. FIG. 3 depicts an example implementation of PFTs 75-77, which includes a state machine 60, configuration registers 62, and storage for the following: a confidence counter 110, an L2 demand miss counter 112, a Prefetch (PF) hit counter 114, an age counter 116, a PFT tier tracker 118, and a match window start pointer 128, a last demand address pointer 130, a next fetch address pointer 132, and a prefetch limit pointer 134. Exemplary usage and updating of these various elements are described below.

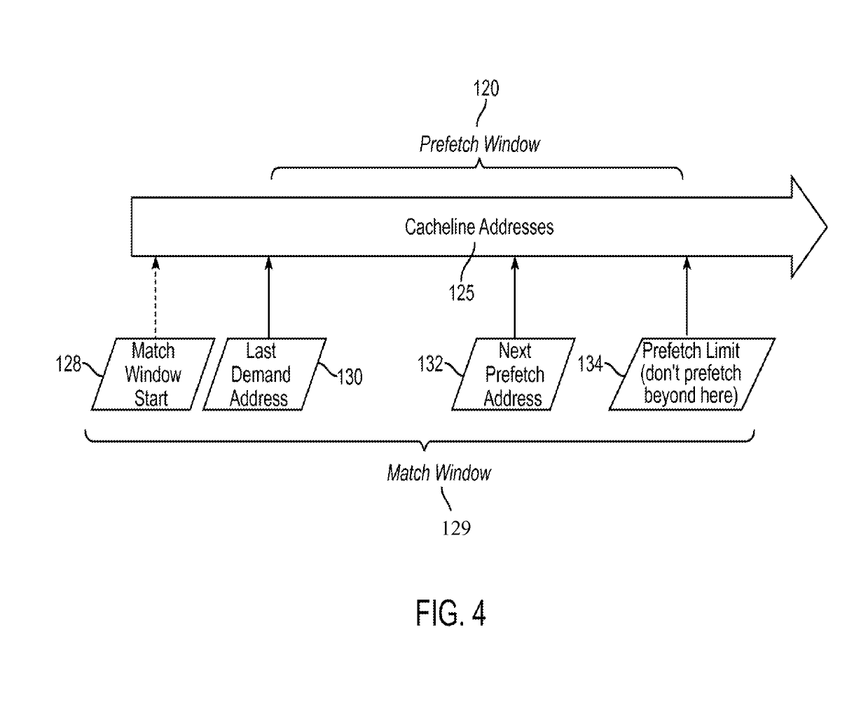

FIG. 4 depicts a diagram of the relative arrangement of the pointers described above, for a given PFT, within a set of cacheline addresses 125. In particular, FIG. 4 depicts that each PFT's match window start pointer 128 and prefetch limit pointer 134 defines a match window 129, and last demand address pointer 130 and prefetch limit pointer 134 defines a prefetch window 120. Each PFT also can be associated with a priority indicator. The priority indicator can be based on a relative priority of a thread or other resource that issued the demand request that caused that PFT to be allocated. Some implementations may provide per-core (per virtualized core) PFTs, while others may provide a pool of PFTs that are shared among multiple cores (virtualized cores). Where virtualization is used, there may be multiple physical cores, and multiple virtual cores per physical core, and the pooled versus separate PFT decision can be at the physical or virtualized level.

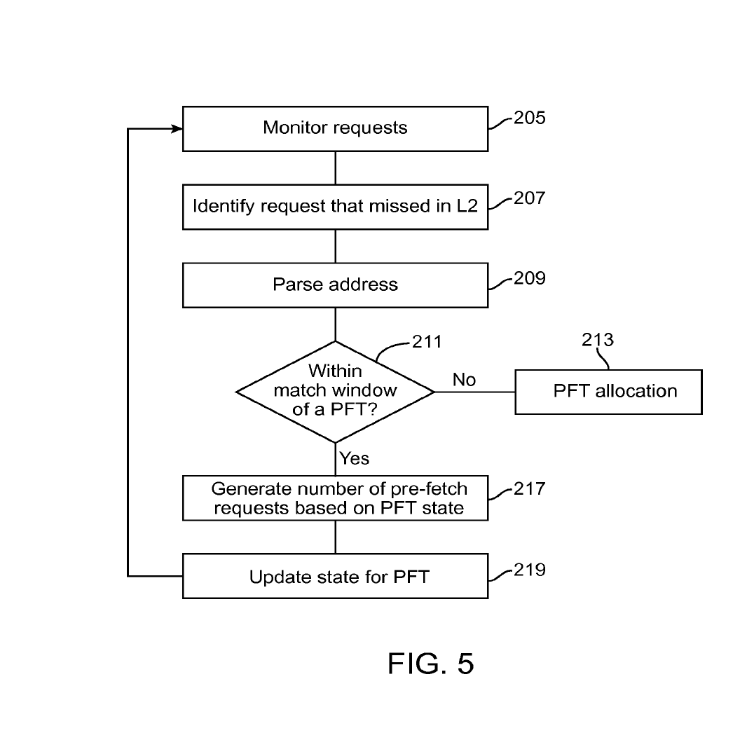

FIG. 5 depicts an example operation of PFU 35. As depicted, demand requests in request stream 45 are made available to PFU 35, and in a particular example, to each of the PFTs 75-77. Each demand request can include a memory address that contains data (the memory address can be at a cache line granularity, or more specific). As such, each of these demand requests will cause installation of a cacheline containing that data in L2 cache 29, in typical implementations. PFU 35 can monitor 205 these requests (in an example, each PFT 75-77 receives and monitors 205 these requests). Such monitoring can include identifying 207 which requests missed in L2 cache 29; this information can be sent by L2 cache pipeline 28 to PFU 35 via coupling 47, for example.

Each PFT 75-77 can determine (211) whether that address is within a respective match window 125 of that PFT. If not, then a PFT allocation sub-process 213 is initiated. Otherwise, a set of zero or more pre-fetch requests is generated. The set has a number dependent on PFT tier 118, and can include zero, such that no pre-fetching occurs. State for the PFT is updated (219). The state machine (e.g., state machine 60) in each PFT can perform these actions. In this example, each PFT 75-77 performs some portion of the actions, and can stop operation based on how intermediate results of the actions. For example, each PFT with a match window that does not overlap the address in the request does not need to perform the remainder of the actions. Some memory regions can be indicated as not available for pre-fetching, in some implementations.

If no PFT had a match window overlapping with the address in a demand request, then PFT allocation 213 is performed. In one example, PFT allocation includes initializing confidence counter 110 to 2, and an initial PFT tier 118 is associated with a zero-sized pre-fetch set. Age counter 116 can be initialized to 0.

Arbiter 80 receives pre-fetch requests generated from each PFT 75-77, and determines which, and in which order, pre-fetch requests are to be submitted to TRU 26. Arbiter 80 also can indicate to PFT allocator 65 situations requiring maintenance of PFTs 75-77. For example, if two PFTs generate pre-fetch requests for the same cacheline, that is an indication that the pre-fetch windows of those two PFTs have overlapped, and one of them can be deallocated. In such a circumstance, which data to be maintained for those two PFTs can be an implementation decision (e.g., to preserve a higher tier PFT, which pre-fetches more cachelines each time or a lower tier PFT that pre-fetches fewer).

As explained above, when a PFT is in a lowest tier of prefetching, it does not cause prefetching. So, a PFT must move up at least one tier in order to begin prefetching. However, under some circumstances, that PFT may be deallocated without ever having prefetched any data if certain conditions are not met. In one implementation, each PFT moves up prefetching tiers in response to a stride of cache lines in demand requests being regular in time, and in address stride, and these requests continuing to miss in L2 cache 29. In general, PFTs can move down prefetching tiers in response to addresses in demand requests being irregular in time or in address space, or demand addresses hitting in cachelines that were prefetched.

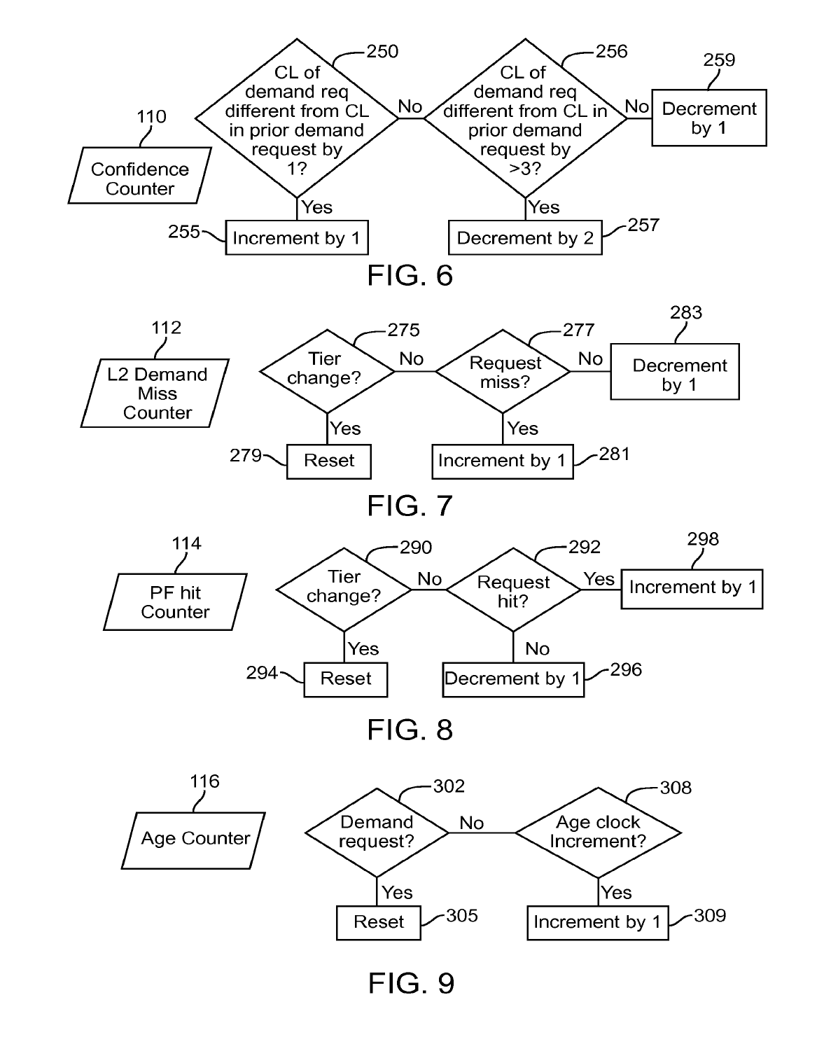

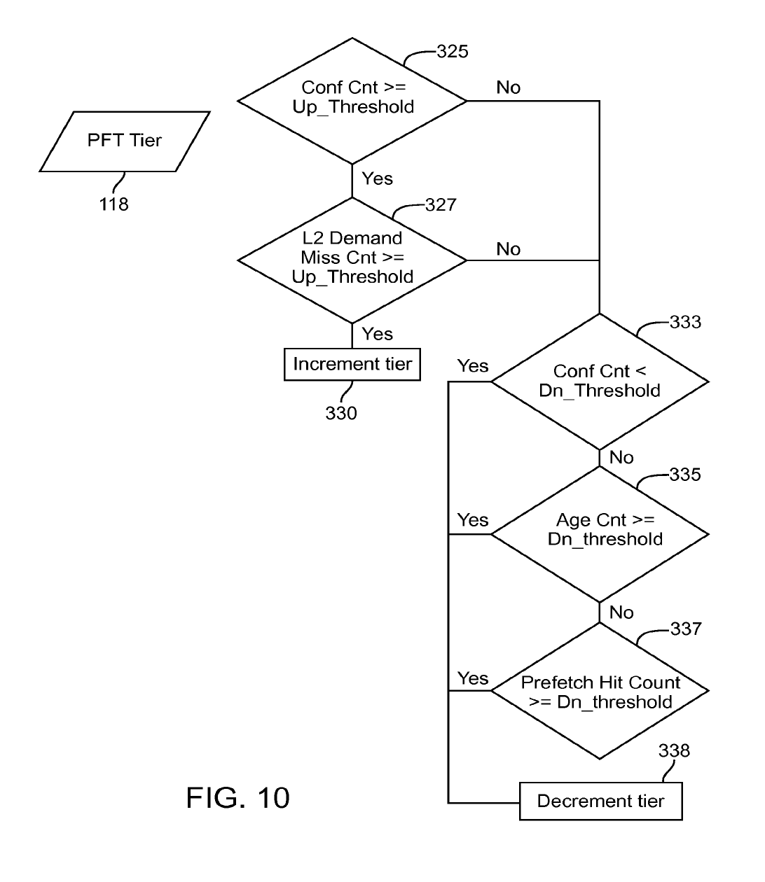

FIGS. 6-9 depict a more-specific example of updating PFT state used as inputs to determine when to change PFT tier, and FIG. 10 depicts a more-specific example of how to use these inputs. FIG. 6 depicts that it is determined whether a Cache Line (CL) for a demand request is different from the CL in a last demand request (in that window) by one CL (can be forwards or back). If so, then confidence counter is incremented by 1. If not, then it is determined whether the CL differs from the CL in the prior demand request by more than 3 CLs. If so, then the confidence counter is decremented by 2, and otherwise decremented by 1. Recalling that the example initialized the confidence counter to 0, FIG. 6 gives an example where if the next requested CL is quite different from the prior demanded CL, then the confidence that the PFT is tracking a sequence of requests for which pre-fetching will be useful is greatly reduced. But, if the difference is less, then the confidence is lowered more slowly, to account for the possibility of request reordering. There are different logically equivalent implementations to this example, and any self-consistent approach to tracking this information can be provided. For example, confidence counter 110 can be initialized at a different value, and incremented or decremented differently, and in response to different disparities between CLs in requests.

FIG. 7 depicts that L2 demand miss counter 112 is reset (279) in response to a change in tier (275), and otherwise, if the request is a miss (277), L2 demand miss counter 112 is incremented (298), and if a hit, decremented (296).

FIG. 8 depicts that in response to a tier change (290), PF hit counter 114 is reset (294), and otherwise, if a request hit (292), then PF hit counter is incremented (298) and otherwise decremented (296).

FIG. 9 depicts that age counter 116 is reset (305) in response to a demand request within match window 125, and otherwise incremented (309) for each age clock increment determined (308). For example, the age clock can be some fraction or multiple of a clock supplied to PFU 35. The fraction or multiple can be set in a self-consistent manner with respect to a limit to which age counter 116 is compared, described below.

FIG. 10 depicts that prefetch tier 118 is incremented (330) in response to confidence counter being equal or greater than (325) a respective up threshold value for the confidence counter, and an L2 demand miss count being greater than or equal (327) to a respective up threshold. Each of these up thresholds can be stored in configuration registers 62, and can be specific for the current tier. Conversely, if either determination 325 or 327 was negative, and if confidence counter 110 is less than (333) a respective down (dn) threshold, or age counter 116 is greater than or equal (335) to a respective dn threshold, or if prefetch hit counter 114 is greater than or equal (337) to a respective dn threshold then, prefetch tier 118 is decremented (338). Each respective dn threshold can be stored in configuration registers, and also can be specific to the prefetch tier.

There are a number of implementation variations to the example process of FIG. 10. For example, the various determinations can be performed in parallel and appropriate logic provided to determine whether to increment, decrement, or neither. For example, determinations 325 and 327 can be “and'ed” while determinations 333, 335 and 337 can be “or'ed” to decrement.

In one example, an initial pre-fetch tier (tier 0) prefetches 0 CLs, tier 1 prefetches 4, tier 2 prefetches 8, and tier 3 prefetches 12, which is a maximum. By way of example, upon an initial L2 miss for a demand request, a PFT is allocated at tier 0, and in response to a second sequential request that misses, the PFT will be increased to a tier 1 and will begin prefetching. However, the up thresholds are set for tier 1 to require 4 more demand requests for sequential CLs, and 3 more misses in order to increase to tier 2. A tier 2 to tier 3 increase can be similarly conditioned. By way of example, a PFT at tier 2 can be moved to tier 1 in response to 3 demand requests hitting prefetched cachelines, or the age since the last demand request within the match window for that PFT being “more” than the respective dn threshold for that value. By way of example, while L2 demand miss counter 112, prefetch hit counter 114 and age counter 116 are each reset when there is a tier change, confidence counter 110 is not. Thus, in such example, confidence counter 110 for a tier 2 PFT will be higher than for a tier 1 PFT. So, in response to there being a demand request within the match window for the tier 2 PFT, but different from the last demand request in that match window by 3 cache lines, the confidence counter will be decremented by 2, which is twice the rate of increment, so that in only two such large misses, the tier 2 PFT will drop to a tier 1 PFT, and similarly for tier 1 to tier 0.

While not separately depicted, last demand address pointer 130 is updated for each demand request received within match window 125, next prefetch address pointer 132 is updated in connection with generation of pre-fetch requests. Prefetch limit 134 can be static or dynamic, or can be dynamic to a hard stop. For example, prefetch limit can have a hard stop at a at a page boundary, but could be dynamically adjusted so long as the PFT continues to track an active pattern of requests.

In the above disclosure, a variety of values tracked, updated, and compared with respective thresholds. While the disclosure provided certain examples related to initializing, incrementing and decrementing such values, the disclosure is not limiting as to how self-consistent approaches within the scope of the disclosure can be incremented. Also, different thresholds may be appropriate for different implementations than the example here. Such thresholds may exposed to modification by software and could be set differently for different workloads. Such threshold can be adjusted in response to profiling of cache and pre-fetch behavior, in the aggregate, for particular workloads, or both. For example, reduction in pre-fetching aggressiveness can be tuned by a number of cachelines prefetched at a given tier, how quickly PFT tiers are decremented in response to hits to prefetch lines, non-consecutive cache line demand requests, and request aging. These thresholds may be set based on how large of an instruction reorder window is available in a particular implementation. While the above-disclosure was in the context of a multiprocessor system, where requests seen by CM 10 can come from multiple different processors, the aspects disclosed herein also can be implemented in a single processor system. The term ‘processor’ includes any of a variety of machine structures that can process or handle data, including, for example, a Digital Signal Processor, fixed function circuitry, input/output (I/O), or even functional units within processor. Still further, ‘processor’ includes virtualized execution resources, such that one set of physical execution resources can be abstracted as multiple physical processors. An operative distinction is whether support for prefetching data into relatively local storage, from relatively remote storage is provided, and subsidiary distinction that may call for implementing the disclosure are the capability of reordering of demand requests, from out of order processing, multithreading, or both.

Modern general purpose processors regularly require in excess of two billion transistors to be implemented, while graphics processing units may have in excess of five billion transistors. Such transistor counts are likely to increase. Such processors have used these transistors to implement increasing complex operation reordering, prediction, more parallelism, larger memories (including more and bigger caches) and so on. As such, it becomes necessary to be able to describe or discuss technical subject matter concerning such processors, whether general purpose or application specific, at a level of detail appropriate to the technology being addressed. In general, a hierarchy of concepts is applied to allow those of ordinary skill to focus on details of the matter being addressed.

For example, high level features, such as what instructions a processor supports conveys architectural-level detail. When describing high-level technology, such as a programming model, such a level of abstraction is appropriate. Microarchitectural detail describes high level detail concerning an implementation of an architecture (even as the same microarchitecture may be able to execute different ISAs). Yet, microarchitectural detail typically describes different functional units and their interrelationship, such as how and when data moves among these different functional units. As such, referencing these units by their functionality is also an appropriate level of abstraction, rather than addressing implementations of these functional units, since each of these functional units may themselves comprise hundreds of thousands or millions of gates. When addressing some particular feature of these functional units, it may be appropriate to identify substituent functions of these units, and abstract those, while addressing in more detail the relevant part of that functional unit.

Eventually, a precise logical arrangement of the gates and interconnect (a netlist) implementing these functional units (in the context of the entire processor) can be specified. However, how such logical arrangement is physically realized in a particular chip (how that logic and interconnect is laid out in a particular design) still may differ in different process technology and for a variety of other reasons. Many of the details concerning producing netlists for functional units as well as actual layout are determined using design automation, proceeding from a high level logical description of the logic to be implemented (e.g., a “hardware description language”).

The term “circuitry” does not imply a single electrically connected set of circuits. Circuitry may be fixed function, configurable, or programmable. In general, circuitry implementing a functional unit is more likely to be configurable, or may b e more configurable, than circuitry implementing a specific portion of a functional unit. For example, an Arithmetic Logic Unit (ALU) of a processor may reuse the same portion of circuitry differently when performing different arithmetic or logic operations. As such, that portion of circuitry is effectively circuitry or part of circuitry for each different operation, when configured to perform or otherwise interconnected to perform each different operation. Such configuration may come from or be based on instructions, or microcode, for example.

In all these cases, describing portions of a processor in terms of its functionality conveys structure to a person of ordinary skill in the art. In the context of this disclosure, the term “unit” refers, in some implementations, to a class or group of circuitry that implements the functions or functions attributed to that unit. Such circuitry may implement additional functions, and so identification of circuitry performing one function does not mean that the same circuitry, or a portion thereof, cannot also perform other functions. In some circumstances, the functional unit may be identified, and then functional description of circuitry that performs a certain feature differently, or implements a new feature may be described. For example, a “decode unit” refers to circuitry implementing decoding of processor instructions. The description explicates that in some aspects, such decode unit, and hence circuitry implementing such decode unit, supports decoding of specified instruction types. Decoding of instructions differs across different architectures and microarchitectures, and the term makes no exclusion thereof, except for the explicit requirements of the claims. For example, different microarchitectures may implement instruction decoding and instruction scheduling somewhat differently, in accordance with design goals of that implementation. Similarly, there are situations in which structures have taken their names from the functions that they perform. For example, a “decoder” of program instructions, that behaves in a prescribed manner, describes structure supports that behavior. In some cases, the structure may have permanent physical differences or adaptations from decoders that do not support such behavior. However, such structure also may be produced by a temporary adaptation or configuration, such as one caused under program control, microcode, or other source of configuration.

Different approaches to design of circuitry exist, for example, circuitry may be synchronous or asynchronous with respect to a clock. Circuitry may be designed to be static or be dynamic. Different circuit design philosophies may be used to implement different functional units or parts thereof. Absent some context-specific basis, “circuitry” encompasses all such design approaches.

Although circuitry or functional units described herein may be most frequently implemented by electrical circuitry, and more particularly, by circuitry that primarily relies on a transistor implemented in a semiconductor as a primary switch element, this term is to be understood in relation to the technology being disclosed. For example, different physical processes may be used in circuitry implementing aspects of the disclosure, such as optical, nanotubes, micro-electrical mechanical elements, quantum switches or memory storage, magnetoresistive logic elements, and so on. Although a choice of technology used to construct circuitry or functional units according to the technology may change over time, this choice is an implementation decision to be made in accordance with the then-current state of technology. This is exemplified by the transitions from using vacuum tubes as switching elements to using circuits with discrete transistors, to using integrated circuits, and advances in memory technologies, in that while there were many inventions in each of these areas, these inventions did not necessarily fundamentally change how computers fundamentally worked. For example, the use of stored programs having a sequence of instructions selected from an instruction set architecture was an important change from a computer that required physical rewiring to change the program, but subsequently, many advances were made to various functional units within such a stored-program computer.

Functional modules may be composed of circuitry, where such circuitry may be fixed function, configurable under program control or under other configuration information, or some combination thereof. Functional modules themselves thus may be described by the functions that they perform, to helpfully abstract how some of the constituent portions of such functions may be implemented.

In some situations, circuitry and functional modules may be described partially in functional terms, and partially in structural terms. In some situations, the structural portion of such a description may be described in terms of a configuration applied to circuitry or to functional modules, or both.

Although some subject matter may have been described in language specific to examples of structural features and/or method steps, it is to be understood that the subject matter defined in the appended claims is not necessarily limited to these described features or acts. For example, a given structural feature may be subsumed within another structural element, or such feature may be split among or distributed to distinct components. Similarly, an example portion of a process may be achieved as a by-product or concurrently with performance of another act or process, or may be performed as multiple separate acts in some implementations. As such, implementations according to this disclosure are not limited to those that have a 1:1 correspondence to the examples depicted and/or described.

Above, various examples of computing hardware and/or software programming were explained, as well as examples how such hardware/software can intercommunicate. These examples of hardware or hardware configured with software and such communications interfaces provide means for accomplishing the functions attributed to each of them. For example, a means for performing implementations of software processes described herein includes machine executable code used to configure a machine to perform such process. Some aspects of the disclosure pertain to processes carried out by limited configurability or fixed function circuits and in such situations, means for performing such processes include one or more of special purpose and limited-programmability hardware. Such hardware can be controlled or invoked by software executing on a general purpose computer.

Implementations of the disclosure may be provided for use in embedded systems, such as televisions, appliances, vehicles, or personal computers, desktop computers, laptop computers, message processors, hand-held devices, multi-processor systems, microprocessor-based or programmable consumer electronics, game consoles, network PCs, minicomputers, mainframe computers, mobile telephones, PDAs, tablets and the like.

In addition to hardware embodiments (e.g., within or coupled to a Central Processing Unit (“CPU”), microprocessor, microcontroller, digital signal processor, processor core, System on Chip (“SOC”), or any other programmable or electronic device), implementations may also be embodied in software (e.g., computer readable code, program code, instructions and/or data disposed in any form, such as source, object or machine language) disposed, for example, in a computer usable (e.g., readable) medium configured to store the software. Such software can enable, for example, the function, fabrication, modeling, simulation, description, and/or testing of the apparatus and methods described herein. For example, this can be accomplished through the use of general programming languages (e.g., C, C++), GDSII databases, hardware description languages (HDL) including Verilog HDL, VHDL, System C Register Transfer Level (RTL) and so on, or other available programs, databases, and/or circuit (i.e., schematic) capture tools. Embodiments can be disposed in computer usable medium including non-transitory memories such as memories using semiconductor, magnetic disk, optical disk, ferrous, resistive memory, and so on.

As specific examples, it is understood that implementations of disclosed apparatuses and methods may be implemented in a semiconductor intellectual property core, such as a microprocessor core, or a portion thereof, embodied in a Hardware Description Language (HDL)), that can be used to produce a specific integrated circuit implementation. A computer readable medium may embody or store such description language data, and thus constitute an article of manufacture. A non-transitory machine readable medium is an example of computer readable media. Examples of other embodiments include computer readable media storing Register Transfer Language (RTL) description that may be adapted for use in a specific architecture or microarchitecture implementation. Additionally, the apparatus and methods described herein may be embodied as a combination of hardware and software that configures or programs hardware.

Also, in some cases, terminology has been used herein because it is considered to more reasonably convey salient points to a person of ordinary skill, but such terminology should not be considered to impliedly limit a range of implementations encompassed by disclosed examples and other aspects. A number of examples have been illustrated and described in the preceding disclosure. By necessity, not every example can illustrate every aspect, and the examples do not illustrate exclusive compositions of such aspects. Instead, aspects illustrated and described with respect to one figure or example can be used or combined with aspects illustrated and described with respect to other figures. As such, a person of ordinary skill would understand from these disclosures that the above disclosure is not limiting as to constituency of embodiments according to the claims, and rather the scope of the claims define the breadth and scope of inventive embodiments herein. The summary and abstract sections may set forth one or more but not all exemplary embodiments and aspects of the invention within the scope of the claims.

1. A processor system, comprising:
one or more processors;
a cache subsystem coupled with the one or more processors, the cache subsystem comprising a cache, and a prefetch unit, the prefetch unit comprising a plurality of prefetch trackers, each prefetch tracker configured:
to be initialized to track a match window of cachelines, based on an initial demand request from the one or more processors,
to maintain a confidence indicator that increases confidence in response to demand requests for consecutive cachelines within the match window, and decreases confidence in response to requests for non-consecutive cachelines within the match window,
to update a prefetch tier, in response to both (1) the confidence indicator meeting a respective tier increase threshold criteria, and (2) to a number of cache misses for demand requests meeting a respective tier increase threshold criteria, and
to initiate prefetching of a number of cachelines, within a prefetch window, into the cache, from a memory subsystem, the number of cache lines according to a then-current prefetch tier associated with the prefetch tracker.

2. The processor system of claim 1, wherein each of the prefetch trackers is further configured to update the prefetch tier in response to the confidence indicator meeting a respective tier decrease threshold criteria.

3. The processor system of claim 2, wherein each of the prefetch trackers is configured to maintain the confidence indicator by decreasing the confidence by a larger amount in response to consecutive requests being more than two cachelines apart.

4. The processor system of claim 3, wherein decreasing the confidence comprises decrementing a confidence counter, and increasing the confidence comprises incrementing the confidence counter.

5. The processor system of claim 4, wherein the confidence counter is initialized to an initial value when the prefetch tracker is initialized based on the initial demand request.

6. The processor system of claim 1, wherein each of the prefetch trackers is further configured to update an age counter that tracks a length of time since a last demand request within the match window was received.

7. The processor system of claim 6, wherein each of the prefetch trackers is further configured to decrease a prefetch tier in response to the age counter meeting a respective threshold criteria.

8. The processor system of claim 1, wherein each of the prefetch trackers is further configured to track up to 4 pre-fetch tiers, with each tier being associated with a respective number of cache lines that will be prefetched for that tier.

9. The processor system of claim 8, wherein a first prefetch tier is associated with a 0 cacheline prefetch limit, and each subsequent tier has an increased limit of between two and four cachelines.

10. The processor system of claim 1, further comprising an arbiter coupled to receive prefetch requests generated by the prefetch trackers, and to detect prefetch requests for the same cacheline.

11. The processor system of claim 1, wherein the cache is a Level 2 cache, and the one or more processors comprises a plurality of processors, each coupled with a private L1 cache.

12. The processor system of claim 1, wherein the cache subsystem comprises an allocator for allocating the prefetch trackers in response to demand requests and freeing prefetch trackers in response to the prefetch tier being at a lowest level, and the confidence reaching a predetermined value.

13. A process implemented within a cache subsystem for prefetching data, comprising:
receiving a demand request from a processor and responsively allocating a prefetch tracker with a match window that is based on an address in the demand request;
maintaining a confidence indicator by increasing confidence in response to demand requests for consecutive cachelines within the match window, and decreasing confidence in response to requests for non-consecutive cachelines within the match window
updating a prefetch tier for the prefetch tracker, in response to both (1) the confidence indicator meeting a respective tier increase threshold criteria, and (2) to a number of cache misses for demand requests meeting a respective tier increase threshold criteria, and
initiating prefetching of a number of cachelines, within a prefetch window, into the cache, from a memory subsystem, the number of cache lines according to a then-current prefetch tier associated with the prefetch tracker.

14. The process implemented within a cache subsystem for prefetching data of claim 13, wherein the prefetch tracker is allocated from a plurality of prefetch trackers, and further comprising initializing the prefetch tier for the allocated prefetch tracker to a tier 0, in which no prefetching is performed, and the confidence indicator to an initial value.

15. The process implemented within a cache subsystem for prefetching data of claim 14, further comprising incrementing the confidence indicator in response to the confidence indicator meeting a respective tier increase threshold criteria.

16. The process implemented within a cache subsystem for prefetching data of claim 14, further comprising updating the prefetch tier in response to the confidence indicator meeting a respective tier decrease threshold criteria.

17. The process implemented within a cache subsystem for prefetching data of claim 14, wherein maintaining the confidence indicator comprising increasing the confidence in response to consecutive requests being one cacheline apart.

18. The process implemented within a cache subsystem for prefetching data of claim 14, wherein maintaining the confidence indicator comprising decreasing the confidence by a larger amount in response to consecutive requests being more than two cachelines apart than in response to consecutive requests being two cache lines apart.

19. The process implemented within a cache subsystem for prefetching data of claim 14, wherein maintaining a confidence indicator comprises decrementing a confidence counter, and increasing the confidence comprises incrementing the confidence counter.

20. The process implemented within a cache subsystem for prefetching data of claim 14, further comprising updating an age counter that tracks a length of time since a last demand request within the match window was received and decreasing a prefetch tier in response to the age counter meeting a respective threshold criteria.

21. The process implemented within a cache subsystem for prefetching data of claim 14, further comprising detecting prefetch requests generated from multiple allocated prefetch trackers that are for the same cacheline, and responsively merging the prefetch trackers
